(19) United States
(12) Patent Application Publication
(10) Pub. No.: US 2008/0091684 A1
(43) Pub. Date: Apr. 17, 2008

(54) INTERNET-BASED BIBLIOGRAPHIC DATABASE AND DISCUSSION FORUM

(76) Inventors: Jeffrey Ellis, New Hyde Park, NY (US); Lori Ellis, Franklin Sq., NY (US); Adam Penstein, Woodmere, NY (US); Aryeh Goldsmith, Brooklyn, NY (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/549,847

(22) Filed: Oct. 16, 2006

(51) Int. Cl. G06F 17/30

(52) U.S. Cl. 707/10

(57) ABSTRACT

An Internet technology-based system (e.g., Web site) allows users to filter and evaluate the quality, validity, interpretation and significance of information through a process of online discussion and ratings. The system leverages the inter-connection of the Internet to tap the expertise of users anywhere in the world, such that filtering and evaluation emerges dynamically from the process of discussion and rating. In an illustrative implementation, the system infrastructure includes a series of data bases, a rating process, discussion forum, mechanisms for site organization and operation, and user interfaces. The database may include an index of citations, users, visitors, authors, experts, editors, and journal open access policy. The databases, rating process, discussion forum, and other elements of the system function to facilitate communication by the fostering of comment and criticism about the stated literature. In turn, one would expect improved understanding and interpretation of the literature. Visitors may make contributions to the database, and such contributions are shared with those of common interest in a way to stimulate discussion amongst experts in the stated topic. In addition, the use of the stated databases may be used in a way as to offer experts and listed corresponding authors the ability to create enhanced profiles. These enhanced profiles may be displayed as an author's unique web page. Content will be provided by authors, allowing them to both embellish on their published work, and to provide original content consistent with the publishing policies of the respective journal in which the stated work was published. A document management system for solicitation, verification, organization, and integration of this data is described.

### FIELD OF THE INVENTION

The present invention relates to online bibliographic databases and discussion forums, and more particularly to a computer-based system for enhancing database content and stimulating comment, criticism, and rating of published literature facilitated by a networking system to bring together those with common interest and expertise.

### BACKGROUND OF THE INVENTION

Internet-based bibliographic databases are well known in many academic fields, especially in medicine. The databases are valuable tools for scholarly research, and serve as a means for medical clinicians to stay informed of the most current research in a particular field. The databases contain bibliographical information on numerous articles from a variety of journals. These databases allow users to search for articles by querying the database by author, subject, or keyword. Oftentimes, additional search fields can also be searched. The search results are returned in the form of a list of articles. Each result contains a citation to the article, so that the user can retrieve the article if so desired. More sophisticated databases usually provide an abstract of the article for review, and possibly a hypertext link to the article in an online journal.

However, there are a number of drawbacks to the online bibliographic databases. While these databases serve well in their role as a search engine, they lack many other desirable functions. For instance, the ability to determine the importance of a particular article based upon its reception by others skilled in the field is absent from the present citation databases. This creates difficulty in determining which articles to read and which should receive higher priority. For example, in the field of medicine, it is estimated it would take incredible and impossible 627.5 hours per month for a clinician to read all the published literature in their given field.

Though access to all indexed publications is critical, weighting search results based on literature most often accessed, watched, discussed, e-mailed, or with highest ratings is valuable. Highlighting such publications is also beneficial when attempting to scan current “hot” topics, without a specific search term in mind. Subcategorizing blocks of literature into fields of interest can be of benefit to achieve the latter goal.

Another drawback of citation databases is that a proportion of published literature in the database is not freely accessible. Internet access to many articles is restricted by limited on-line availability and/or subscription fees. Often times, however, a free copy of the article is available somewhere on the internet, but its citation is not included in the database. For example, the majority of publishers allow the primary author to deposit some embodiment of their work on-line for free. To comply with publisher requirements, many authors publish the stated embodiment either on their institutions website, or on their personal website. This practice is known as self-archiving.

To date, many problems exist with self-archiving. First, most authors are unaware of their publishers policies regarding self archiving. Secondly, self-archiving to institutional and/or personal websites does not directly link this submission with the index of published literature. Consequently, the self-archived articles cannot be found using citation databases. That is to say, the majority of those searching for an article would not know that an embodiment of the full text has been self-archived by the author.

To facilitate the self-archiving of published literature it would be useful to both assist in the creation of author home pages and to encourage self-archiving to these home pages. If and when published work has already been self-archived elsewhere (i.e.: institutional home page), it would be equally beneficial to solicit links directly to these works from the author's home page. The structure of these pages will allow those searching the literature to identify those articles that are available in some form from the author.

Another drawback of citation databases is the limited usefulness of the data contained therein. While it is important to be able to find and read current articles, it is often times not enough information. A user may have questions about the article or may desire to know how the article was received by others skilled in the relevant art. The present invention presents an online discussion forum to meet these needs.

Online discussion forums are known in the art, although they have not been used in conjunction with citation databases. These forums allow users to post comments on a website for other users to see. The idea being that multiple users can carry out a discussion by reading and responding to each other's posts. However, the known discussion forums have a number of drawbacks. Perhaps the greatest drawback is that it is impossible to verify the true identity of the authors of the various posts. Without knowing the true identity and credentials of the author of a post, it is impossible to determine how credible the post is and how much weight to give to the opinion expressed. Consequently, it is not possible to conduct a truly valuable discussion using the discussion forums known in the art.

Central to providing meaningful commentary and obtaining reliable answers to posted questions is the engagement of experts and authorities in a topic. To accomplish these goals, a system of identifying users who post to the forum is required. Furthermore, a system is needed that would create an authority hierarchy, so a user can determine the credentials of the author of a posted comment.

### OBJECTS AND SUMMARY OF THE INVENTION

Accordingly, it is an object of the present invention to provide a network-based system for filtering and evaluating a citation database for quality, validity, significance, and interpretation through a process of online discussion, rating, and access tracking.

It is another object of the present invention to provide a new and improved system for the identification and notification of experts in a field (authorities), for the purpose of generating meaningful discussion.

It is still another object of the present invention to provide a new and improved system for the notification of those with common interests, for the purpose of generating meaningful discussion.

It is yet another object of the present invention to provide a new and improved system for the categorization of a citation database based on subject, source, and user base statistics.

It is a further object of the present invention to provide a new and improved system for the notification of authors for the purpose of generating meaningful discussion about their literature, or literature related to their own.

It is still a further object of the present invention to provide a new and improved system for the assignment of articles from a citation database to selected users, and management thereof.

It is yet a further object of the present invention to provide a new and improved system for the generation of user or author home pages.

It is another object of the present invention to provide a new and improved system for the solicitation and archiving of author deposits to these home pages, resulting in an open access database.

It is still another object of the present invention to provide a new and improved system for the identification of the fields of interest, and colleagues of authors within a citation database.

It is yet another object of the present invention to provide a new and improved system for semi or fully automated registration of a user via use of citation data.

It is a further object of the present invention to provide a new and improved system for the monitoring of the citation database, and comments made to it.

These and other objects of the present invention are achieved by providing a system for locating and discussing scholarly content comprising a server coupled to a database, wherein the server is accessible to system users via a network, and wherein the database contains citation data of the scholarly content. A search module is included on the server that is used by the system users to query the database for specific citation data based on search criteria inputted by the system users. A comment module is also included on the server that allows the system users to create and post comments to the database that are associated with a specific citation, wherein other system users can view the comments. The preferred embodiment of the system has many other features, such as self archiving and journal clubs.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention. For illustration purposes only, the drawings will pertain to the fields of science and medicine.

In the drawings:

FIG. 1 is a screenshot of a “home page” used in connection with the present invention.

FIG. 2 shows a sample of a search result from a query posted to a database of the present invention.

FIG. 3 shows a sample of a detailed view of an article which was retrieved by clicking on article number two shown in FIG. 2.

FIG. 4 shows a sample of how a given user's authority level might be identified when contributing to an article.

FIG. 5 is a screenshot of a subspecialty page.

FIG. 6 shows several sample navigation bars.

FIG. 7 shows how one might access the table of contents for a given journal, by selecting the month and date of publication.

FIG. 8 is a flowchart illustrating a method of identification and contact of experts in accordance with one embodiment of the present invention.

FIG. 9 shows a flowchart for correspondence to a REPLY to a post.

FIG. 10 is a screenshot of an author home page.

FIG. 11 is a screenshot of a comment entry form page.

FIG. 12 is a screenshot of a rating form page according to the present invention.

FIG. 13 is a screenshot of an advanced search page and an RSS feed tool.

FIG. 14 is a flowchart for solicitation of authors to self-archive on their own personal home page.

FIG. 15 is a schematic diagram of system hardware.

FIG. 16 is a block diagram of a database structure and database subsets according to the present invention.

FIG. 17 is a flow chart of user interaction with interface and flow of data according to the present invention.

FIG. 18 is a screenshot of a registration form page according to the present invention.

FIG. 19 is a screenshot of a user preferences/profile page according to the present invention.

FIG. 20 is a flowchart of a method creating and managing a journal club in accordance with one embodiment of the present invention.

### DETAILED DESCRIPTION

Embodiments of the present invention are described herein in the context of a system, method, and apparatus for connecting users in an online computer system based on their expertise and interest in a subject. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive disclosed herein.

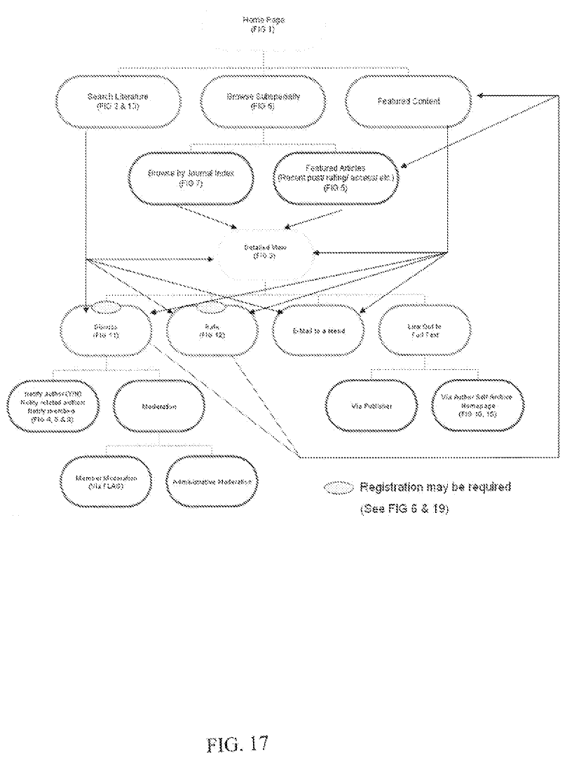

Reference is now made to FIG. 17, which is a simplified flowchart illustration of a method interaction with the interface in accordance with one embodiment of the present invention. Although the description of the invention is presented as a logical sequence of navigational steps a user might take, it is not meant to represent the only such embodiment. The first step a user would take in accessing the system is visiting the system homepage which is a web portal that gives users access to the system server and database.

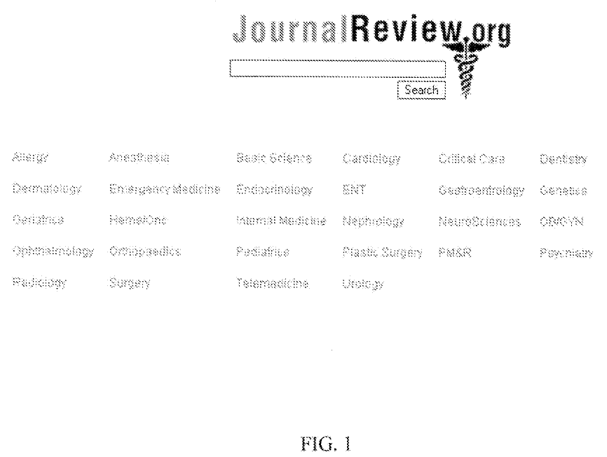

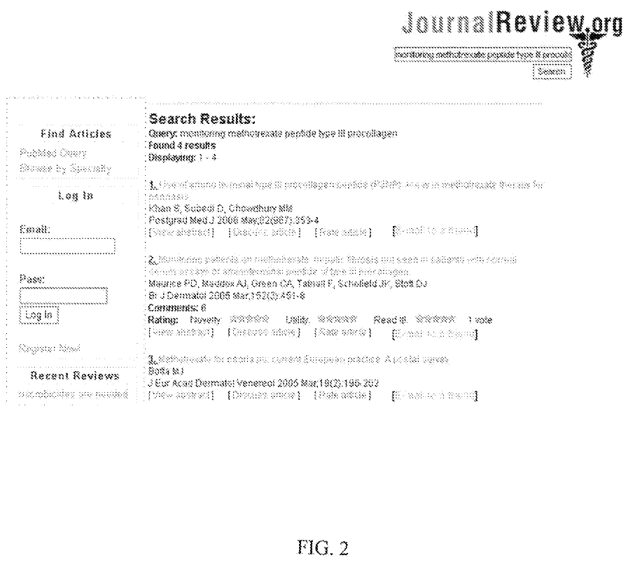

FIG. 1 shows an exemplary home page, in this case for a website titled JournalReview.org. This page is generally the starting point for any user attempting to use the system of the current invention. This page houses the search bar which gives users access to the system's search module. The search module is accessed via a search bar that allows a user to search the citation database (see FIGS. 2 & 13). The search module is discussed in greater detail below.

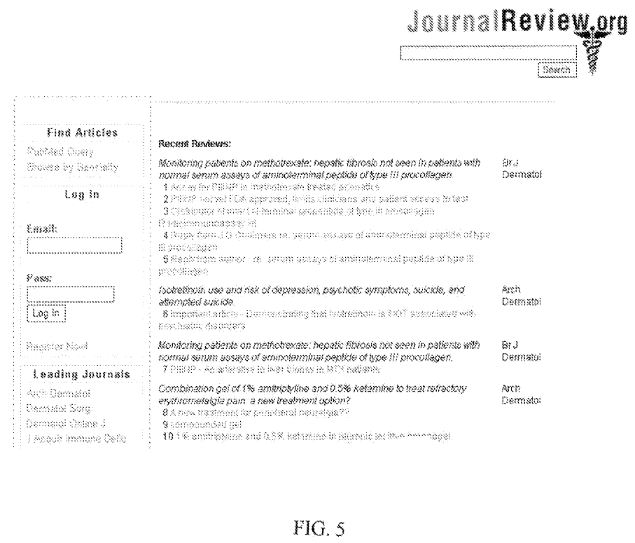

The home page also allows users to link directly to pages that contain subspecialty content. The subspecialties may include in this example allergy, anesthesia, basic science, cardiology, critical care, dentistry, dermatology, emergency medicine, endocrinology, ENT, gastroenterology, genetics, geriatrics, hematology/oncology, internal medicine, nephrology, Neuroscience, OB/GYN, Ophthalmology, Orthopedics, Pediatrics, Plastic Surgery, PM&R, Psychiatry, Radiology, Surgery, Telemedicine, and Urology. From this home page, a user could choose to either search, or browse content via subspecialty (see FIG. 5). This allows users to navigate directly to content that interests them.

Additionally, though not shown in the figure, featured content may be displayed on the home page that is selected from the database of citations based on ratings, discussion, access statistics, or other means. All this data is stored in the data structure associated with each individual citation and stored on the database of the system.

The search bar may be found on all subsequent pages. Search boxes on subsequent pages may be logically limited, based on the page viewed. For example, from the home page, there would be no limits. From a dermatology specialty page, the search may be limited to dermatology. From the JAMA journal page, the search may be limited to publications within JAMA, etc.

FIG. 2 shows an exemplary search result obtained by conducting a search via the search bar. The search results include data such as citation title, authors, journal of publication, date of publication, volume, issue, and pages. This page also gives the user access to the discussion module and rating module, discussed in greater detail below. The user has the option to view the abstract, discuss an article, rate an article, or e-mail the citation to a friend. If there are comments in the forum data with a submission ID number (PMID) that matches the PMID of the search result, the presence of such comments may be indicated (as in FIG. 2 result “2. Monitoring patient on methotrexate . . .” Comments: 6.) If there are ratings in the Rating Data where the PMID matches the PMID of the search result, a summary of these ratings may be displayed as demonstrated in FIG. 2 result “2. Monitoring patient on methotrexate . . . . ” Rating: Novelty ***** Utility: ***** Read It! ***** 1 vote. A navigation bar is seen on the left. This navigation bar, or a variation thereof, may be seen on several pages. It is understood that the PMID is only one possible variable out of a number of possible variables that may be used to match citation data with forum data.

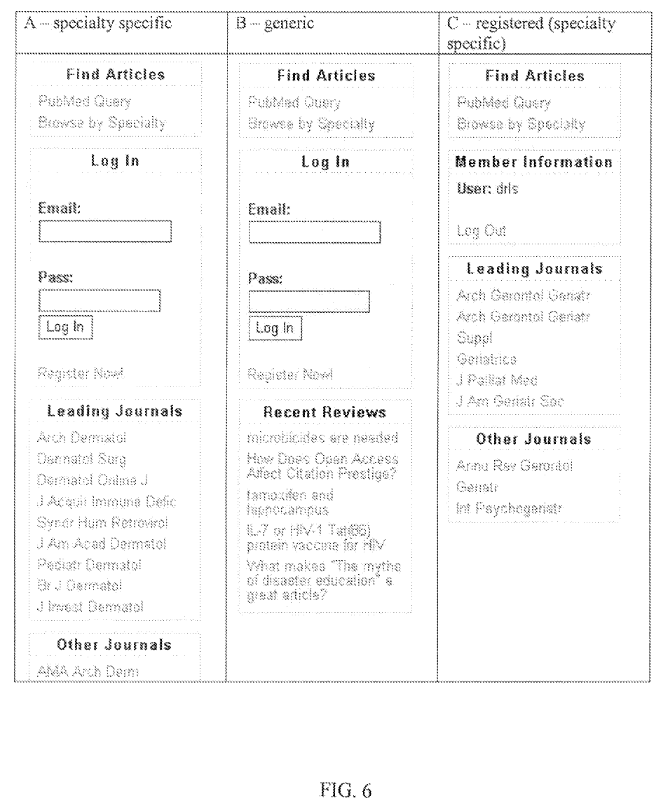

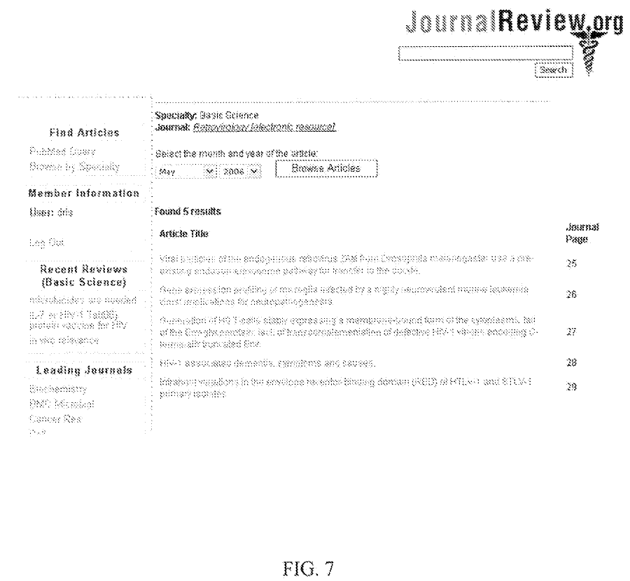

FIG. 6 shows several sample navigation bars. These navigation bars are dynamic, and vary in content to complement the current view of the user in an appropriate way. From the navigation bar, one might choose to query the database (i.e.: PubMed Query) or return to the subspecialty view (i.e.: Browse by Specialty). One could log in (i.e.: 6A and 6B show a user not logged in 6C shows a user logged in). If one is logged in, they may be able to edit their profile, including (not shown) their favorite journals, topics (MeSH headings), authors, notification preferences, author home page, etc. From specialty specific navigation bars (6A and 6C), one can choose to browse by a leading or other journal within the specialty (see FIG. 7.). Other data that may be shown are recent posts (6B), highly accessed articles, other articles identified to be of interest, members on-line, the institutions currently represented on-line, journal clubs represented on-line, members of one's own journal club on-line, etc.

FIG. 7 shows how one might access the table of contents for a given journal, by selecting the month and date of publication. Shown below are titles and pages of the journal Retrovirology for May 2006. From this view, ratings, commentary, and access data may be shown (not shown in the figure). In addition, recent reviews from the specific journal or subspecialty may be shown either below the table of contents or within the navigation bar (in this example, recent reviews are shown for the subspecialty in the navigation bar).

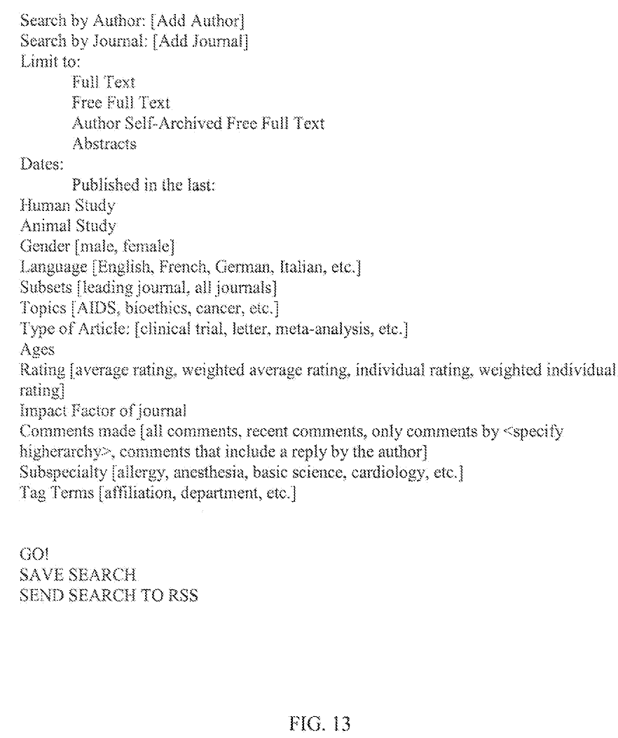

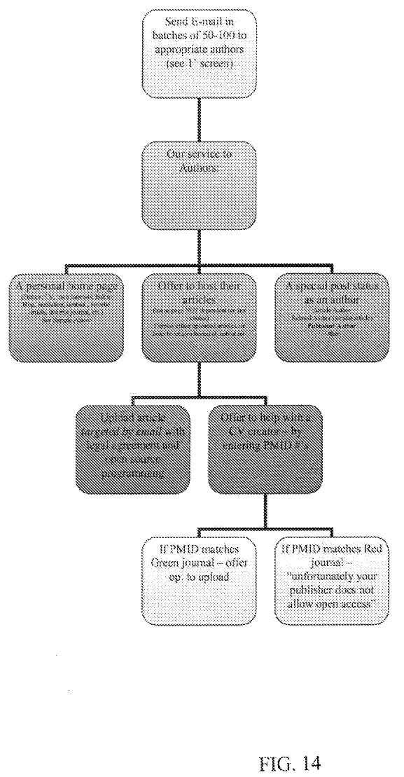

FIG. 13 demonstrates a sample advanced search of the search module. The use of an advanced search allows a visitor to extract more specifically the data of interest. Via the advanced search, one may create limits based on author name, journal title, articles with links to full text, links to free full text, abstracts, links to author self-archived full text, dates of publication, human studies, animal studies, gender, language, journal subsets including topics and subspecialties, type of article, age of subjects, rating, and tag terms (i.e.: affiliation, abstract, etc.). This search can be used to both return results directly, or to generate RSS feeds (See FIG. 14). Many of the search criteria available to a user via advanced search are unique to the present invention, including limits based on rating, available commentary, access data, and available full text (both from journals, and from author self-archiving), specialty, authors with home pages, authors who self-archive, and registered members.

When using ratings to limit an advanced search, one may utilize individual ratings (i.e.: limit to novelty >4, and Utility >5), or summary ratings. Summary ratings may be calculated via a number of algorithms, including simple averaging and weighted averaging. Weighted averaging may be calculated by combining an “authority factor” into the rating. For example, the ratings made by authors of related articles may have a rating factor “X”, ratings made by a journal club a rating factor of “Y”, and ratings made by a standard user a rating factor of “Z”. A weighted average could be calculated by the following formula: X1(Novelty+Utility+ReadIt)+X2(Novelty+Utility+ReadIt)+XNx(Novelty+Utility+ReadIt)+Y1(Novelty+Utility+ReadIt)+Y2(Novelty+Utility+ReadIt)+YNy(Novelty+Utility+ReadIt)+Z1(Novelty+Utility+ReadIt)+Z2(Novelty+Utility+ReadIt) +ZNz(Novelty+Utility+ReadIt)/(Nx+Ny+Nz). Furthermore, this term may be multiplied by an impact factor that is derived based on access statistics, and or citation statistics. Citation statistics may include the ISI Factor and variations thereof, which may incorporate journal, article, or author rank. Access statistics may be independently weighted based upon the status of those interacting with the citation. Similarly, weighted averaging could be calculated for any individual rating component.

FIG. 13 also shows a sample RSS (Rich Site Summary) feed tool. Any standard or advanced search can be converted into a dynamic RSS feed. That is to say, one can easily obtain RSS feeds for a given specialty, journal title, topic, affiliate institution, author, etc. These can be further limited to feed all entries in the database, or only those with a specified rating or authority of commentator. They can also be limited only to those with authors who have self-archived, and/or have personal home pages. These RSS feeds are dynamic, in that when displayed, they will allow visitors to directly add ratings or contribute comments from the pages displaying the feed. This will facilitate, for example, a specific journal to display only positive (high rating) commentary (articles with comments) related to their journal. Visitors to the journal website could interact with these comments directly from the journals site, without having to leave and visit the source site (source of data). This is just one of many conceived examples that illustrate using dynamic RSS to expand the interface.

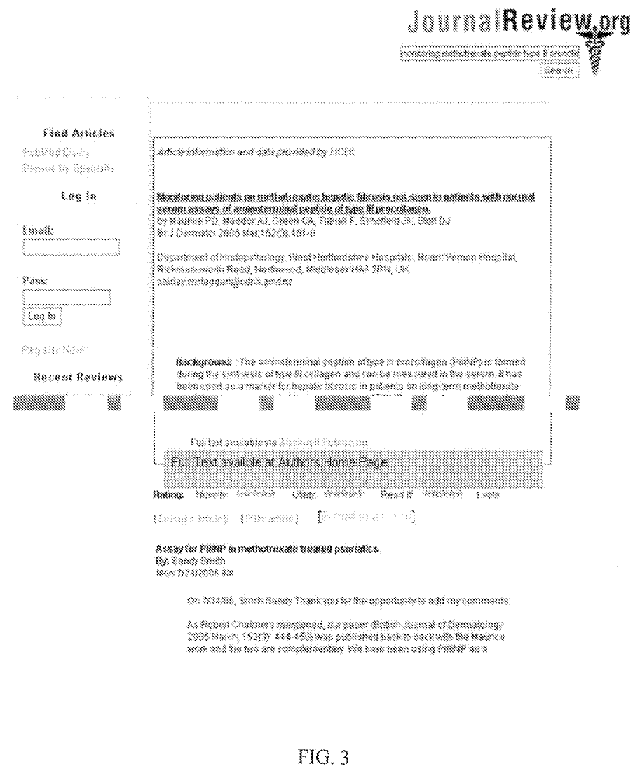

FIG. 5 shows an exemplary screen demonstrating a possible view when one chooses to browse by subspecialty. Displayed are featured reviews that are related to the chosen subspecialty. This category may be assigned based on a variety of variables, allowing some articles or comments to appear in more than one specialty. Variables that may be used to identify appropriate subspecialties include the journal (i.e.: the Archives of Dermatology would always be relevant to at least the subspecialty of Dermatology); article subject headings (MeSH headings) (i.e.: if an article from the Archives of Dermatology had a MeSH heading of “obsessive compulsive disorder”—and this subject heading was also listed as a common topic of interest in psychiatry—the article would appear both in Dermatology and Psychiatry if a comment is made); extraction of terms used in the post (i.e.: if a member includes key terms or phrases that match common topics of interest in a given specialty); the profession or specialty of the commenter (i.e.: if the person writing the review is an Allergist, the comment might be of interest to other Allergists); etc. They may be featured due to any or combination of a number of algorithms including most recent posting, highest rating, most accessed paper, etc. In the figure shown, recent reviews are displayed. Displayed is the title of an article, along with the associated journal. Below the title, one sees the subjects of a series of comments made by users. Choosing any of these comments will bring a visitor to a detailed view of the article, as seen in FIG. 3.

FIG. 5 also demonstrates alternative navigational options for seeking desired content. One may choose, to browse directly by Journal Index (as illustrated in FIG. 7). To do so, a user would first choose a journal by name (in this example, Retrovirology). The journal could be chosen from a list of all journals, list of journals categorized by subspecialty, by search, or other means. Once selected, the date of interest is selected, and a list of articles published on or near that date in the specified journal is displayed. This creates a view much like a table of contents for the given issue. The illustrated example provides article titles with corresponding page number, any citation or other captured data may be shown at this time (i.e.: number of comments, views, rating, author names, e-mail to a friend, related articles, etc.).

As demonstrated above, there are multiple views, techniques, and sequences that one might use to select a specific article or comment and go to the detailed view (FIG. 3). These descriptions are only meant to represent sample navigational pathways to this point, and are not meant to be all conclusive. Those in the art would quickly realize that there are numerous other ways not stated hear that one might progress to the detailed view. It is also understood that all sorting, querying and filtering carried out by the system is conducted based upon the values of various variables of the data structures stored in the database.

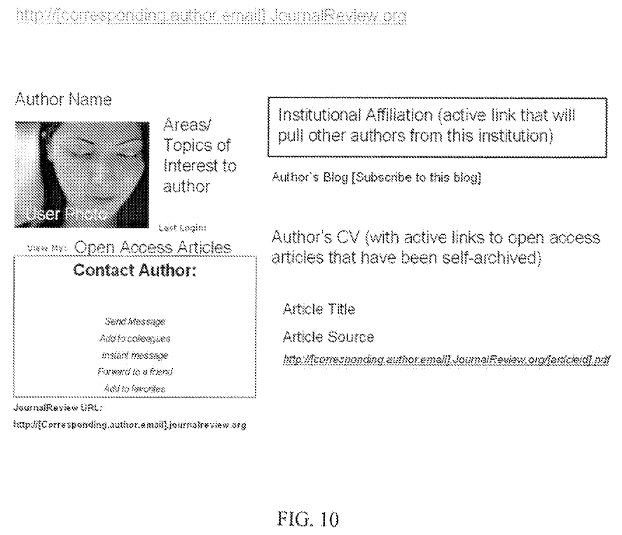

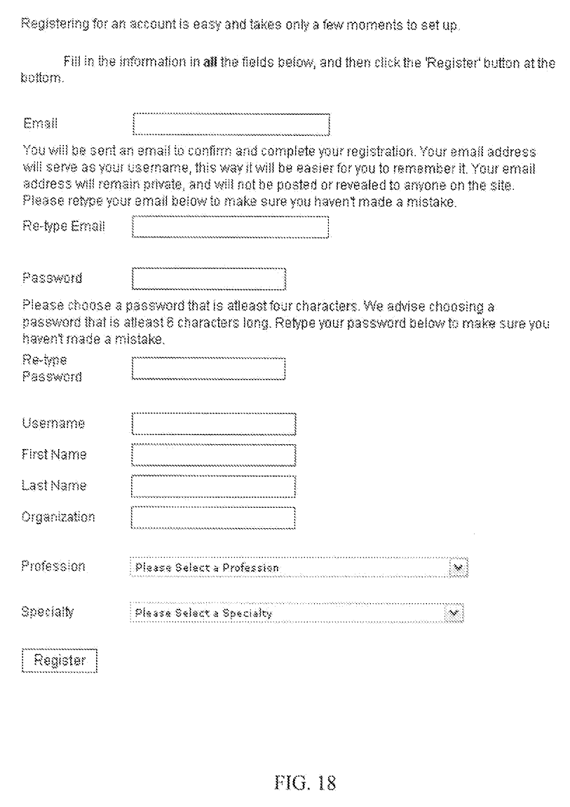

FIG. 3 shows a detailed view of an article. It is truncated due to space constraints. Shown is citation data, including article title, authors, journal name, date, volume, issue, and pages of publication, author affiliation, corresponding author contact, abstract, and a link to full text provided by the publisher. In addition to the traditional data available as part of a citation database, the system of the present invention provides a link to the authors home page, in this case, hosted at JournalReview.org. A sample author home page can be seen in FIG. 10 and is described in more detail below. In some cases, an embodiment of the full text may be displayed via the authors home page. It may be stated on the detailed view, or other views, that such content is available directly from the author. Ratings are displayed, as are options to discuss or rate an article, a visitor may be required to become a user via registration (FIG. 18). Comments about the article are then shown, which include a subject, author, date and time stamp, and body. Each comment has a “Flag” option, which allows users to identify inappropriate content for review (not shown). In addition, other articles of interest may be displayed to users. These articles can be chosen based on related articles, articles with comments by matching users, articles being tracked by common users, or articles being tracked by common journal clubs. In addition, the user may be offered the option to gain additional information on any text that the user highlights. For example, they may be offered a dictionary definition of a highlighted word from the title, abstract, or of from the full source if available via self-archiving or otherwise.

FIG. 18 shows a sample registration form. Registration of a said user may be facilitated via use of the citation database if the user is found within the said database. In the illustrated example, a user is asked to supply e-mail, password, username, first name, last name, organization, profession, and specialty. After the registration form is submitted, the registration may be confirmed via a variety of means that may include notification sent to the e-mail provided with additional instructions to complete the registration process. It is easy to imagine additional data that might be solicited during a registration process that are not shown here. Alternatively, if a user registering for the system is an author within the citation database, they may utilize the citation database to facilitate both registration and conformation of registration. For example, a user might search for a recent publication that has within the citation their own corresponding e-mail address (provided as a corresponding author). In this case, registration data that includes the author name, affiliation, department, e-mail, as well as colleagues, and subjects of interest could be pre-populated into the registration form as it is extracted from citation metadata.

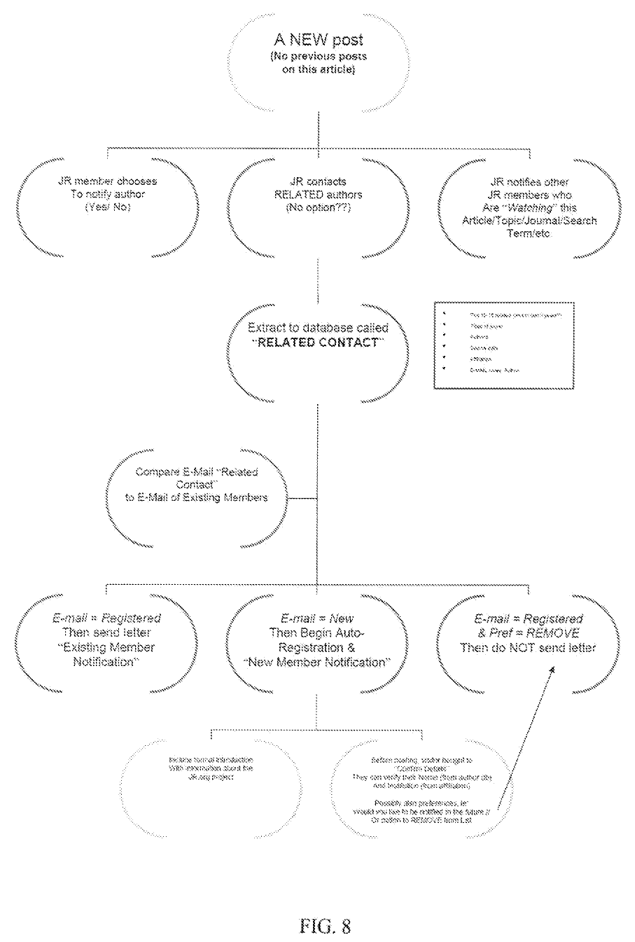

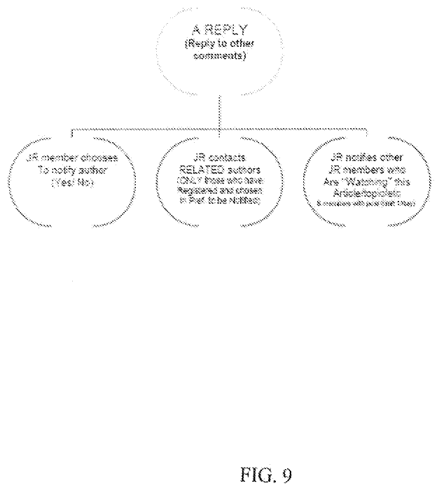

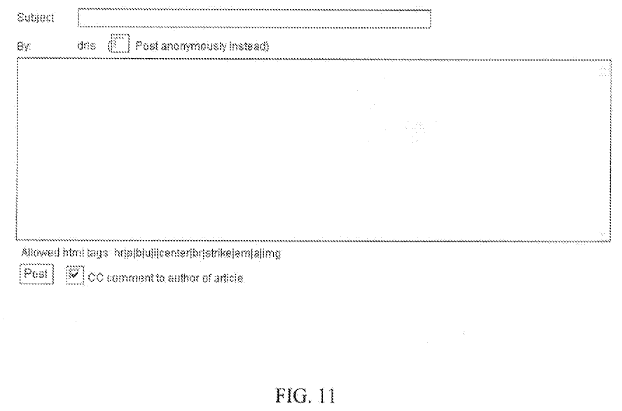

FIG. 11 shows a sample discussion/comment entry form used as part of the discussion module of the present invention. Displayed is a space for the comment subject and body. Also, one can choose to post an attributed comment (default), or anonymously. Below the body of the post, one can choose to notify the author of the article if desired. Submission of a post will automatically trigger the algorithm described in FIGS. 8 and 9, which facilitates notification of “experts”, and/or those with known interest in the topic, article, or journal. Submitted comments may or may not be subject to moderation. This may or may not be dependent upon the source of the post (i.e.: status of the poster). A hierarchy may be created to give posters a status. The following hierarchy or a similar variation may be used (least to greatest):
1. anonymous post;
2. attributed post of a general user, who is not listed as a corresponding author;
3. attributed post of a user who has published to the stated index (i.e.: Author of an article in the citation database that is NOT related to the current article);
4. attributed post by pharmaceutical or corporate body
5. attributed post by regulatory agency
6. Editor of the journal in which the article is published;
7. Author of a related publication (i.e.: Author of an article in the citation database that is related to the current article by access trends, or by matching subject heading); and
8. Corresponding author of the article being discussed.
   Additional privileges and attribution may be provided for those authors who create a personal home page, and those who help to facilitate self-archiving. To facilitate discussion, and engage those with interest in a specific topic—notification will be sent to members with matching interests (i.e.: matching MeSH headings), and authors of related articles. Authors who are notified will be registered in a semi-automated way to facilitate their participation.

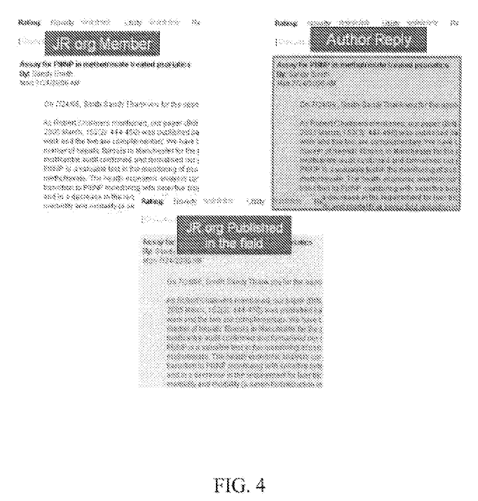

The user status (i.e.: author, related author, etc.) can be highlighted for easy identification by a variety of ways. One example would be via variation in color and font of the background, or foreground, as shown in FIG. 4.

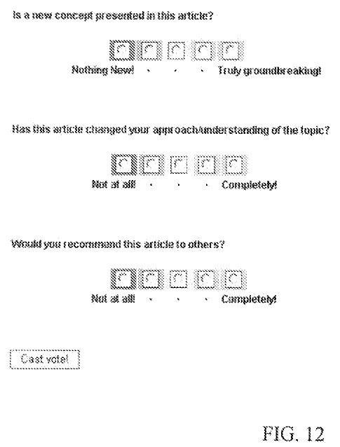

FIG. 12 shows a sample rating form of the ratings module of the present invention. Additional questions, or advanced ratings may be solicited beyond this simple form illustrated. In the sample figure, three questions are asked. They are “Is a new concept presented in this article?”, “Has this article changed our approach/understanding of the topic?”, and “Would you recommend this article to others?”. In this example, a scoring system of 1-5 is offered.

Reference is now made to FIG. 8, which is a simplified flowchart illustration of a method of the identification and contact of experts in accordance with one embodiment of the present invention. “Experts” in this example are composed of authors who have published articles related to that being discussed. The algorithm could also be used to contact other users who have expressed interest in the given topic. The purpose of this illustration is to show how those “external” to the discussion, but within the database (i.e.: not registered members, but listed in the database of citations) can be utilized to recruit experts on a topic. In this illustration, the use of an e-mail address within the citation is required. There may be times when an e-mail of a corresponding author is not available, and one could easily imagine a variety of alternative means for contacting the author(s). These could include, but are not limited to: 1. Searching the citation database for other articles by the given author, for an associated e-mail address listed with an alternative publication; 2. Searching the citation database for other articles by co-authors, for an associated e-mail address listed with an alternative publication; 3. requesting the e-mail (or requesting a message to the author to be forwarded) via contacting the journal editor; 4. requesting the e-mail (or requesting a message to the author to be forwarded) via contacting the affiliate institution; 5. U.S. Postal Mail.

FIG. 9 shows a sample algorithm for a reply to a post (i.e.: discussion thread). A detailed description of a sample algorithm follows. When a new post is submitted to an article, a number of notifications may be sent out, which may include notification to members who are “watching” the article/topic/journal/search term/ etc, the author of the article, related authors, and members who have been inactive for a period of time but have searched in the past for terms related to the new post (not shown on algorithm). To facilitate the contact of related authors, whom exist in the citation database, but may or may not exist in the user database, a “Related Contact” data set is created. This set includes citation data for the top specified number of related articles (i.e.: top 10-15 related articles published in the past 3 years), with titles of papers, authors name, source data, affiliation, and e-mail of corresponding author. The e-mail of corresponding authors collected is then compared to the existing user database. If the e-mail matches an existing user email, appropriate notification is sent (i.e.: “Existing Member Notification”). If the e-mail is new, than this author is sent a welcome letter, along with information about the topic under discussion, and why their viewpoint as an expert would be meaningful and important to the community. If they choose to register, the process is facilitated as much of the user data has been collected from citation data. A profile of preferences and subjects of interest may also be automated via the use of subject headings that match articles the author has published in. In addition, they may or may not be given privileges to contribute to only specified articles where they are identified as an expert with no further registration required. At any time, a registered member, or non-registered author can choose to remove future notification. Members with no system activity for N days may also be notified if terms that they had used in previous searches match subject headings or content of a new post.

Reference is now made to FIG. 9, which is a simplified flowchart illustration of a method of correspondence when a reply to a comment is made in accordance with one embodiment of the present invention. In this case, only those who have chosen to be notified, or those who have contributed content to the thread may be notified.

FIG. 10 shows a sample author home page. Illustrated is one possible algorithm for the web address, as well as sample content. For example, a confirmed e-mail address may be used as a prefix to journalreview.org in a way such that a.b.c.@123.com would generate the home page http://a.b.c.123.journalview.org. Alternatively, an ID number, author name, or user generated prefix may be used. Sample content for the author home page would include photo, curriculum vitae, institution affiliation, blog, contact information, as well as a list of publications for which the author has self-archived. The entry of the curriculum vitae may be facilitated by the citation database, so that entries can both be checked for accuracy and links can be provided to abstracts, ratings, and commentary. One way to facilitate this would be via author submission of citation ID number's (i.e.: PMID numbers or via other reference numbers, or via a custom search that would query the citation database for matching author name, publication dates, affiliation, journals, and or subject headings.)

In addition, the curriculum vitae may be compared to the self-archive policy of the associated publisher, and the relevant policy be easily displayed for the author's review next to each article. If policy is in support of self-archiving, such an option would be presented. If a self-archiving policy requires a delay (i.e.: self-archiving may only be done six months after publication), the author may be offered the opportunity to begin the self-archiving process—but the availability of the content would be held until permitted by publisher policies. In this case, a “count down” may be displayed, (i.e.: Article X will be accessible in 8 days, consistent with publisher Y's policies). If a Notification of claimed infringement is made that is contradictory to the published open access policies of that publisher, the internet service provider may offer the user assistance via a semi-automated counter-notice. Via use of registration data, and citation data, the following items of the counter-notice can be auto-populated: contact information, identification of removed literature, a statement under good faith that the material was mistakenly taken down, a statement consenting to the jursidictions of the users local US court or if outside the US the court in which the internet service provider is found. This data could be presented to an end user, and an electronic signature from the user requested to file the counter-notice on their behalf. The user may or may not be asked to agree to such actions to be taken on their behalf upon the submission of materials.

Still referring to FIG. 10, Author/User homepages may also be used to display a collection of the author/user comments and ratings, and articles they are actively discussing. It can be used to identify comments they have made to articles in which they are authors of, as well as articles related to their own. Statistics may be displayed in the form of a table or graph to show the percentages of the above. The page may also display the specialties in which the author publishes in, and comments in. It may show links to their friends, colleagues, or other authors. Linking to other authors may be facilitated by automatically including all co-authors of a paper (all papers) in which the author is listed. For example, if Author X has written a paper Y with co-authors A,B, and C—A,B,&C may be listed as the authors colleagues and links be provided to their home pages if they are registered members in the system. In addition, if the co-author A is an author on a separate paper, with co-authors D,E,&F, Authors D,E, and F may also be listed as “colleagues once-removed” to author X. This automated use of a citation database to link authors with related interests and publications may continue to the Nth degree.

Referring to FIGS. 3 & 10, a sample of a detailed view of an article is shown—in this case, by clicking on article number two shown in FIG. 2. In this truncated view, we can see that the full citation of the article, including title, author, source, affiliation, and abstract. Below the source data, we see detailed information about the rating, followed by comments made by members. Each comment has a “flag” option (not shown), that allows visitors to notify administrators of inappropriate content. A visitor could also choose to discuss, rate, or e-mail this article to a friend. A link to full text of the article is offered, as would a link to the corresponding author's personal home page is available. The user may act upon the individual user's attributed comment or home page in a number of ways. She can send a private message to the user, forward the user's profile to a friend, “watch” the user (as described elsewhere), or invite the user into an existing journal club (as described elsewhere).

Reference is now made to FIG. 14, which is a simplified flowchart illustration of a method of solicitation of author home pages and promotion of self-archiving in accordance with one embodiment of the present invention. Publisher policy data (SelfArchive Data) would be composed of a list of publishers, their respective journals or publications, and their policies on self-archiving. An example of this type of data source already in existence is http://www.sherpa.ac.uk/remeo.php. This data could be utilized to selectively contact authors to both educate and offer opportunity for self archiving. Authors notification of self-archiving opportunities could be initiated in a variety of conceivable ways. The entire citation dataset could be utilized to facilitate a comprehensive and systematic notification of all authors within the dataset if desired. Notifications could be generated based on author name, subject area, active articles, articles being discussed, or based on publisher. Verification that the user submitting a manuscript is an author of the paper could be done in an number of ways, including but not limited to comparison of citation database corresponding e-mail and user database e-mail, via referral of previously confirmed users (colleagues), via contact of the affiliation listed, as well as other techniques. Verification may be used all of the time, or alternatively only when a user initiates the process of self-archiving. In the following example, where the internet service provider uses the citation database to contact an author, verification standards may inherently be met. For example, if publisher X allows author self-archiving, a search would be conducted of the citation data limited to journals by the publisher X that are consistent with the publishers policy. For example, if a publisher does not allow self-archiving for six months, the search would be restricted to only those publications older than six months). This data set may be further limited by restricting only to those authors who have provided a corresponding e-mail.

As described elsewhere, if an e-mail is not found for a given citation, an extended algorithm may be employed to identify contact data for the corresponding author of the said citation. The corresponding authors of the said search would then be contacted, alerting them of their publishers policies on self-archiving and the depository available via JournalReview.org's facilitated author home page creation. Construction of such a page, and self-archiving of articles would also offer a contributor a specified status or rank in the user base. If an author chooses to create a home page, and self-archive, they will be able to use the citation database to self-populate meta-data for the uploaded citation (i.e.: title, authors, affiliation, subject headings, etc.) and upload a pre or post-print version of the manuscript as determined by the stated publishers policies. Additional meta-data may be solicited, including references/citations used in the manuscript, and disclosure of author and co-author conflicts of interest. The metadata, as well as the self-archived manuscript may complaint with standards of the field including the open access initiative complaint metadata.

Users will also be able to upload their Curriculum Vitae. The Curriculum Vitae will be compared to the citation database, to facilitate accuracy as well as to facilitate accurate colleague networking as described elsewhere. Citations listed in the curriculum vitae that are not found in the citation database may be highlighted, so that the user may check them for accuracy and correct if needed. The curriculum vitae may will be checked for additional self-archive opportunities as described with FIG. 10. In addition, and or alternatively, this process may be used to notify authors about depositories that exist in their affiliate institution or elsewhere. The home page then could be used as described above, or used to host links to external depositories. Several events can trigger the re-sending of an invitation to create a homepage. First, a regular update can be sent as a “reminder”. For example, every Monday an update could be sent to invitees who had not yet responded. Alternatively, an author may be re-invited as comments are made to their article, or those related. Alternatively, an invitation may be re-issued as a request of another user. After the invitation has been re-sent a suitable number of times, the process can terminate. Further, the process can be terminated at the request of the invited individual.

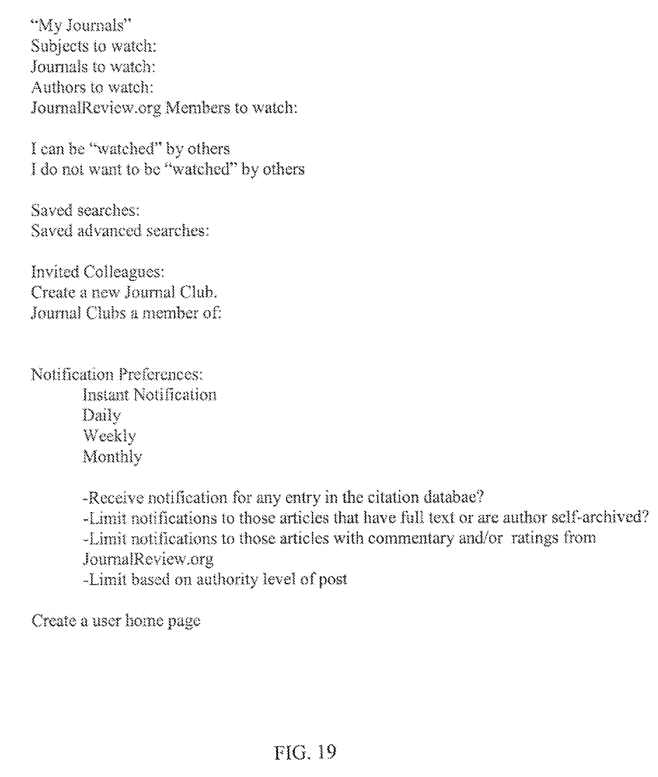

FIG. 19 shows sample preferences offered to users. Users may invite colleagues to join the system. The interface allows the user to enter one or a plurality of e-mail addresses for colleagues they would like to invite to the system. The message that will be sent to the colleagues may include standard language describing the present system, the benefits of joining and the steps required to join the system. A user may choose to include a personal message, along with the standard invitation. A user may choose to include a specific invitation to an existing or newly established journal club—in addition to invitation of general membership. The invited colleague may initiate the process to join the system by clicking directly on an HTML link included in the e-mail message. In one embodiment of the invention, the user can import e-mail addresses from a standard computerized address book (such as that provided by Microsoft Corporation, “Microsoft Outlook”). The system can further notify the inviting user when her invitee accepts or declines the invitation to join the system.

Still referring to FIG. 19, users may create a list of “My Journals”, which will enable them to see recent commentary on a customized list of journals, rather than pre-defined subspecialties. They may choose to “watch” a variety of content, and receive e-mail or other notification about updates to this content. Such content may include subjects, journals, authors, members, or any saved standard or advanced search. Users may also choose settings to allow, or disallow other users from watching them. Users may create a new journal club, or ask to be invited to other existing clubs. Notification preferences can be set so that users receive notification at desired interval consisting of pre-selected and solicited content. Users also have the option to create a personal user web page.

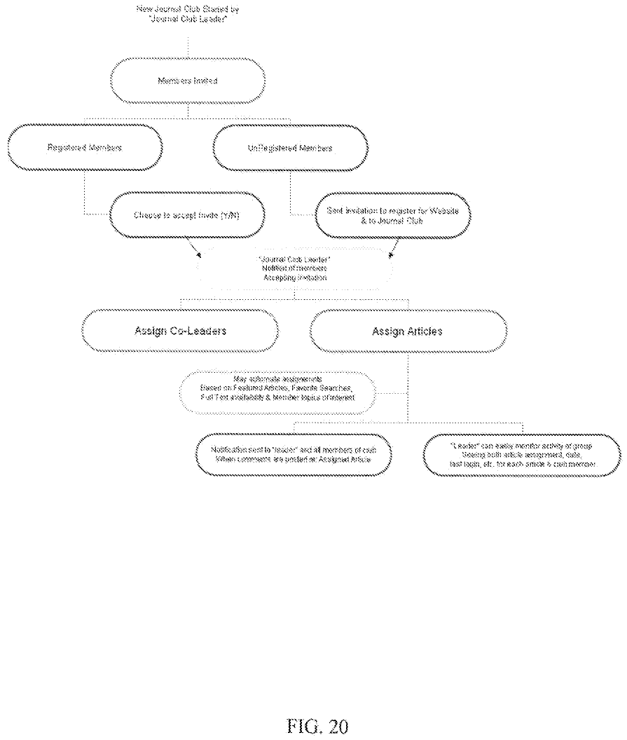

FIG. 20 is a simplified flowchart illustration of a method creating and managing a journal club in accordance with one embodiment of the present invention. First, a journal club is started by a registered member, who becomes the “Journal Club Leader”. The leader then invites other members, via e-mail. The leader may be required to provide additional descriptive data, including name, affiliation, etc. of invited members to the journal club. The e-mail submitted will be compared to a registered user database, and if a match is found, the registered user is invited to join the journal club. If no match is found, the invitee is identified as unregistered, and an invitation is sent to both register for the website, as well as to join the journal club. When members accept the invitation, the journal club leader is notified, and may begin to assign co-leaders to the club, and assign articles. Assignment of articles and monitoring of member participation may be limited to journal club leaders and co-leaders. Articles may be assigned in a semi-automated way, by matching member's topics of interest with journal club leaders chosen articles, journals, subjects, featured sections, or favorite searches. When a comment is made by a member about an assigned article, all members may be notified if they choose to receive such notification. In addition, members of the club may be monitored for participation and activity by the journal club leader and co-leader. It is also easy to imagine how a hierarchy of leaders might be established, such that some can assign articles, while others can monitor the use of all users.

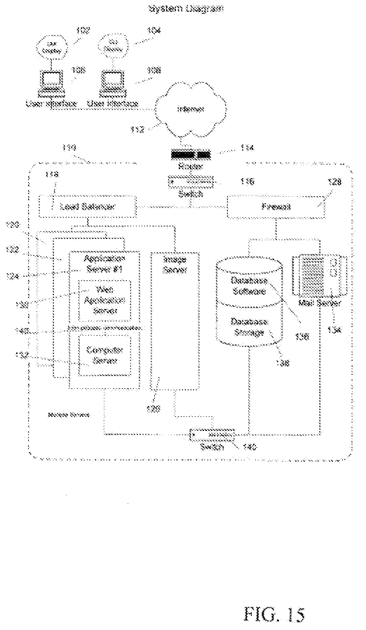

FIG. 15 illustrates the general architecture of a system that operates in accordance with one embodiment of the present invention. As shown in FIG. 15, a plurality of graphical user interface (GUI) displays 102 & 104 are presented on a plurality of user interface devices 106 & 108 connected to an apparatus 110 via the Internet 112. The user interface may be any device capable of presenting data, including, but not limited to, cellular telephones, television sets or hand-held “personal digital assistants”. As used herein, the term “Internet” generally refers to any collection of distinct networks working together to appear as a single network to a user. The term refers to the so-called world wide “network of networks” that are connected to each other using the Internet protocol (IP) and other similar protocols. The Internet provides file transfer, remote log in, electronic mail, news and other services. As described herein, the exemplary public network of FIG. 15 is for descriptive purposes only. Although the description may refer to terms commonly used in describing particular public networks such as the Internet, the description and concepts equally apply to other public and private computer networks, including systems having architectures dissimilar to that shown in FIG. 15. For example and without limitation thereto, the system of the present invention can find application in public as well as private networks, such as a closed university social system, or the private network of a company.

The apparatus 110 is connected to the Internet 112 through a router 114 and a switch 116. As is well known in the relevant art(s), routers forward packets between networks. The router 114 forwards information packets between the apparatus 110 and devices 106 & 108 over the Internet 112. A load balancer 118 balances the traffic load across multiple mirrored servers 120, 122, 124, and a firewall 128 provides protection from unauthorized access to the apparatus 110. The switch 116 may act as a gatekeeper to and from the Internet 112. The components appearing in the apparatus 110 refer to an exemplary combination of those components that would need to be assembled to create the infrastructure in order to provide the tools and services contemplated by the present invention. As will be apparent to one skilled in the relevant art(s), all of components “inside” of the apparatus 110 may be connected and may communicate via a wide or local area network (WAN or LAN).

The apparatus 110 includes an application server 124 or a plurality of application servers 124. The application server 124 comprises a web application server 130 and a computer server 132 that serves as the application layer of the present invention. Yet another server is the image server 126, which has the purpose of storing and providing digital images to other components of the apparatus 110. Also included is a mail server 134, which sends and receives electronic messages to and from devices 106 & 108. Also included are the database software 136 and a database 138.

The Web application server 130 is a system that sends out Web pages in response to Hypertext Transfer Protocol (HTTP) requests from remote browsers (i.e. users of the apparatus 110). That is, the Web server 130 provides the GUI 102 & 104 to users of the system in the form of Web pages. These Web pages sent to the user's device 106 & 108 would result in GUI screens 102 & 104 being displayed.

The apparatus 110 also includes a second switch 140 that allows the components of the apparatus to be interconnected in a local area network (LAN) or a wide area network (WAN). Thus, data can be transferred to and from the various components of the apparatus 110.

As will be appreciated by those skilled in the relevant art(s), this configuration of router 114 and switch 116 is flexible and can be omitted in certain embodiments. Additional routers 114 and/or switches 116 can also be added.

The application server 124, the database(s) 136, 138 and the mail server 134 are shielded from the public Internet 112 through the firewall 128. The firewall 128 is a dedicated gateway machine with special security precaution software. It is typically used, for example, to service Internet 112 connections and dial-in lines and protects the cluster of more loosely administered network elements hidden behind it from external invasion. Firewalls are well known in the relevant art(s).

As will be appreciated by those skilled in the relevant art(s), the inclusion of the firewall 128 is flexible and can be omitted in certain embodiments. Additional firewalls 128 can also be added.

The computer server 132 may include a central processing unit (CPU), a random access memory (RAM) temporary storage of information, and a read only memory (ROM) for permanent storage of information. Computer server 132 may be generally controlled and coordinated by an operating system software. The operating system controls allocation of system resources and performs tasks such as processing, scheduling, memory management, networking, and I/O services, among things. Thus, the operating system resident in system memory and executed by CPU coordinates the operation of the other elements of the apparatus 110.

Although the description of the computer server 132 may refer to terms commonly used in describing particular computer servers, the description and concepts equally apply to other processing systems, including systems having architectures dissimilar to those shown.

Also included is an inter-process communications protocol 140 (IPCP), a set of rules for marshalling and un-marshalling parameters and results. This is the activity that takes place at the point where the control path in the calling and called process enters or leaves the IPCP domain. The IPCP is essentially a set of rules for encoding and decoding information transmitted between multiple process. As will be appreciated by those skilled in the relevant art(s), the inclusion of the IPCP 140 is flexible and can be substituted or omitted in certain embodiments.

The apparatus 110 may also include the image server 126 or a plurality of image servers that manage(s) digital photographs and other human viewable images. The image server 120 may be configured separately from the web server 130. This configuration may increase the scalability of the server apparatus 110. Alternatively, the web server 130 and the image server 126 can be configured together. Examples of image formats that can be managed by the image server 126 include, but are not limited to, Graphical Interchange Format (“GIF”), Joint Photographics Experts Group (“JPEG”), or Portable Network Graphics (“PNG”), or Tagged Image File (“TIF”).

The mail server 134 is a repository for e-mail messages received from the Internet 112. It also manages the transmission of electronic messages (“electronic mail” or “e-mail”). The mail server 134 consists of a storage area, a set of user definable rules, a list of users and a series of communication modules. Its primary purpose in the present invention is the storage and distribution of e-mail messages to the Internet 112.

The databases 136, 138 store software, descriptive data, digital images, system data and any other data item required by the other components of the apparatus. The databases may be provided, for example, as a database management system (DBMS), and object-oriented database management system (ODBMS), a relational database management system (e.g. DB2, ACCESS etc.), a file system or another conventional database package. Thus, the databases 136 & 138 can be implemented using object-oriented technology or via text files. Further, the databases 136 & 138 can be accessed via a Structured Query Language (SQL) or other tools known to one of ordinary skill in the art.

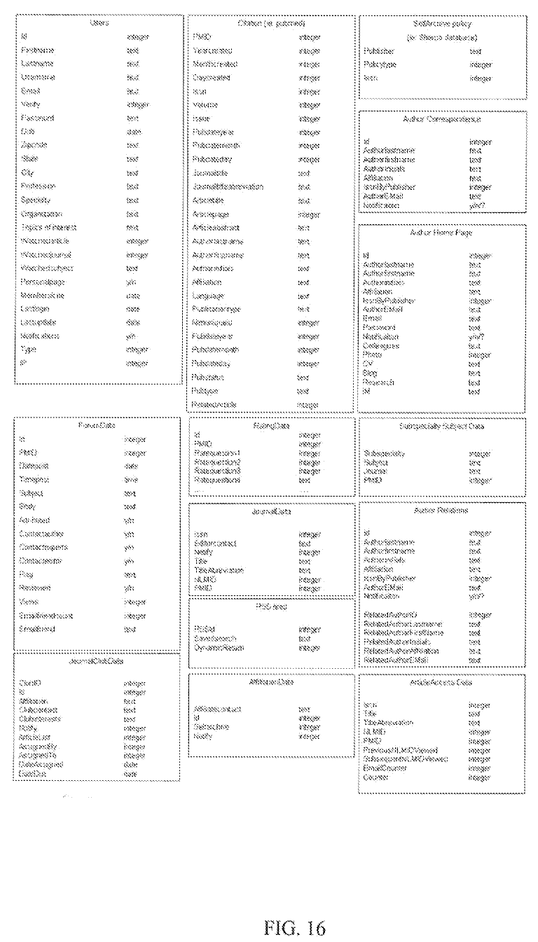

Referring to FIG. 16, various data structures used in conjunction with the present invention are shown. As used herein, user data refers to information that describes a user or characteristics of a user. For example, user data might include a first and last name. Or it might include elements that describe attributes of the user, such occupation, specialty, and areas of interest. Or it may represent a digital image—a photograph—of the user, or other descriptive data.

Examples of descriptive data include reference id (id), first name (firstname), last name (lastname), user name (username), E-Mail (email), verification of user (verify), password (password), date of birth (dob), zip code (zipcode), state (state), city (city), profession (profession), specialty (specialty), organization/affiliation (organization), topics of interest (topics of interest), articles watched (watchedarticle), journals watched (watchedjournal), subject watched (watchedsubject), personal web page (personalpage), membership since (membersince), last date logged in (lastlogin), last update to profile (lastupdate), notification preferences (notification), type of notification (type), IP address (IP).

The citation data refers to data that describes literary citations. This may be related to any literary data, including other citation databases, open archives initiative data, but in no way is meant to be limited to these data sets. Data sets may have duplicate data points, to facilitate communication between the data sets. For example, the citation data and the forum data may both contain a PMID, which allows for comments within the forum data to be displayed with the appropriate citation.

Examples of citation data includes article id (PMID), year article created (yearcreated), month article created (monthcreated), day created (daycreated), ISSN (ISSN), journal volume (volume), journal issue (issue), publication date your (pubdateyear), publication date month (pubdatemonth), publication date day (pubdateday), journal title (journaltitle), journal title abbreviation (journaltitleabreviation), article title (articletitle), article page (articlepage), article abstract (articleabstract), author last name (authorlastname), author first name (authorfirstname), authorinitials (authorinitials), author affiliation (affiliation), article language (language), publication type (publicationtype), national library of medicine unique id (NLMuniqueID), publication date year (pubdateyear), publication date month (pubdatemonth), publication date day (pubdateday), publication status (pubstatus), publication type (pubtype), related articles (relatedarticle).

The self archive policy data refers to data related to publication polices that publishers have related to author self-archiving. Such data already exists for some literature, such as medical literature, in an index called Sherpa/RoMEO database. Data collected would include publisher (publisher), policy type (policytype), and ISSN of relevant journals to the referenced publisher (ISSN).

The author correspondence data describes details and preferences related to authors whom are contacted after discussion is submitted. These include both authors of the article being discussed, as well as authors of related articles to that being discussed. The data set includes a user Id (Id), author last name (authorlastname), author first name (authorfirstname), author initials (authorinitials), author affiliation (affiliation), ISSN number of journal of publication (ISSNbypublisher), author Email (authoremail), and notification preferences (notification).

The author home page data describes content that may be displayed, and used to access display data. This includes author Id (Id), author last name (authorlastname), author first name (authorfirstname), author initials (authorinitials), author affiliation (affiliation), ISSN number of journal articles that author has published (IssnByPublisher), author Email (email), password (password), notification preferences (notification), author's colleagues and friends (colleagues), author photo (photo), author ev (ev), author blog (blog), author research interests (research), author instant messaging (IM).

The forum data describes how commentary and discussion may be organized and collected. Data includes an identification number of the post (id), identification number of the article being discussed (PMID), date of the post (datepost), time of the post (timepost), subject of the post (subject), body of the post (body), attributed or anonymous post (attributed), option to contact the author (contactauthor), option to contact other experts in the field (contactexperts), option to contact the editor of the journal of publication (contacteditor), history and data related to “flagging” of post by members for inappropriate content (flag), of the post was moderated, reviewed, or approved (reviewed), counter of times the article is emailed to a friend (emailfriendcount), e-mail addresses that an article is sent to via email to a friend (emailfriend).

Journal Club Data describes the organization of groups of users into individual clubs for smaller group discussion, moderation, and notification preferences that can be extracted from the general pool of users. Data includes a unique journal club id (clubid), user id or id's of club members (id), affiliation of member or members (affiliation), contact data for the club (clubcontact), areas of interest to the club (clubinterests), and notification preferences for the club (notify).

Data may also include details of article assignments to facilitate on-line and complement in person journal clubs, including date of assignment, user assigning article, assigned user, date for review, article title, etc. Articles may be assigned in a number of ways, including advanced search (assign article along would appear next to RSS feed button as seen in FIG. 13), and via index view that includes article ratings and existing comments, staring “articles of note” (a modified view of FIG. 7). Articles may also be auto-assigned based on a system whereby user topics of interest are matched with selected article subject headings. Additional views may also be used to select an article for discussion in a journal club. (see FIG. 20)

Rating data describes the organization of data collected related to the rating of literature and or the embodiment (i.e.: journal) that contains the stated literature. Data may include rating id (Id), article id (PMID), rating to question 1 (ratequestion1), rating to question 2 (ratequestion2), etc.

Journal data describes contact information and contact preferences for specific journals. Data includes ISSN number of the journal (ISSN), editor contact e-mail (editorcontact), and notification preferences (notify).

RSS feed data describes a dataset of saved searches that are updated in a regular way, and provide relevant feed to those requesting these feeds. Datasets include RSS id (RSSiD), the search elements used to generate the feed (savedsearch), and data related to the dynamic use of these feeds including reply and rating solicited directly from the feed (dynamicreturn).

Affiliation data describes a dataset that collects information related to affiliate institution, to facilitation institutional notification and promotion of self archiving. Datasets include affiliate contact (affiliatecontact), affiliate id (id), self archiving availability and policies (selfarchive), and notification preferences (notify).

Subspecialty subject data may include subspecialty (subspecialty), subject headings of interest to the subspecialty (subject), journals published related to the subspecialty (journal), and PMID numbers related to the journals published within the subspecialty (PMID).

Author relations data may include user ID (ID), author last name (authorlastname), author first name (authorfirstname), author initials (author initials), author affiliation (affiliation), the ISSN of journals or publications the author is cited within (IssnByPublisher), the author email (AuthorEMail), author notification preferences (Notification), colleagues to the author (RelatedAuthorID), colleagues last name (RelatedAuthorLastname), colleagues first name (RelatedAuthorFirstName), Colleagues initials (RelatedauthorInitials), colleagues affiliations (RelatedauthorAffiliation), and colleages e-mail (RelatedAuthorEMail).

Article Access Data may include the ISSN number or other reference number of the said journal (Issn), title of the article (Title), Title abbreviation (TitleAbreviation), ID numbers to identify the said article or publication (NLMID) (PMID), history of article viewed prior to the said article by a user(s) (PreviousNLMIDViewed), history of the subsequent article viewed after the said article by a user(s) (SubsequentNLMIDViewed), number of times article e-mailed to a friend (EmailCounter), number of times article viewed (counter), number of times article cited in other works (citationcounter).

We claim:

1. A system for locating and discussing scholarly content comprising:
a server operatively coupled to a database, wherein said server is accessible to system users via a network, and wherein said database contains citation data of said scholarly content;
a search module on said server that is used by said system users to query said database for specific citation data based on search criteria inputted by said system users; and
a comment module on said server that allows said system users to create and post comments to said database that are associated with a specific citation, wherein other system users can view said comments.

2. The system of claim 1, wherein said database also contains user data, wherein said user data includes user credentials of at least one system user, and wherein user credentials of a system user are made available to other system users in association with a comment posted by said system user.

3. The system of claim 2, wherein said user data includes user credentials of all system users.

4. The system of claim 3, wherein said user credentials that are made available to other system users in association with a comment posted by said system user, include the relationship of said system user to the specific citation associated with the comment posted by said system user.

5. The system of claim 4, wherein said user credentials include the following statuses: anonymous poster, general user, general published author, journal editor, author of a related publication, and corresponding author of the specific citation.

6. The system of claim 1, further comprising:
a notification module that alerts a subset of said system users when a system user posts a comment associated with a specific citation.

7. The system of claim 6, wherein said subset comprises at least one author of said specific citation.

8. The system of claim 6, wherein said subset comprises any system users that have requested to be notified of posted comments that are associated with said specific citation.

9. The system of claim 6, wherein said subset comprises all system users that have requested to be notified of comments posted by said system user.

10. The system of claim 6, wherein said subset comprises at least one system user that has posted a comment associated with said specific citation.

11. The system according to claim 6, wherein said notification is only sent when said system user is an author of said specific citation.

12. The system according to claim 1, further comprising:
a notification module that alerts an author of a specific citation when a system user posts a comment associated with said specific citation, wherein said author is not a system user, and wherein said notification comprises notifying said author of said comment.

13. The system according to claim 12, wherein said notification further comprises requesting that said author register as a system user.

14. The system of claim 1, wherein said search module returns specific citations that match said search criteria, and said search module also returns comments posted by system users that are associated with said specific citations.

15. The system of claim 14, wherein an RSS feed is created to continually monitor said database for new citations and/or comments that match said search criteria and notify a system user who initiated the search of its addition.

16. The system of claim 1, further comprising:
a rating module that allows system users to rate a specific citation, wherein a compilation of user ratings for a specific citation is created by said rating module, and wherein said rating compilation is stored in said database in association with said specific citation and is made available to said users when said specific citation is viewed.

17. The system of claim 16, wherein said compilation includes dynamically calculating and assigning a summary rating to specific citations in the database, wherein the summary rating is a numerical value that represents a measure of overall user preference of said specific citation.

18. A system for automated self-archiving comprising:
a server operatively coupled to a database, wherein said server is accessible to system users via a network, and wherein said database contains citation data and user data;
an author identification module which analyzes said user data to identify which of said system users have authored a work whose citation is part of said citation database;
a website creation module which creates a webpage having a unique address for each author, wherein said webpage is associated with said author; and
an archiving module which allows authors to post a copy of their work to their corresponding webpage.

19. The system according to claim 18, wherein said archiving module also searches said database for citation data related to said author and adds said citation data to said author's webpage.

20. The system according to claim 18, further comprising a publisher-policy-checking module which checks on policies of a publisher of a work found in said citation database regarding author self-archiving, and wherein said publisher policy checking module takes steps to ensure that said publisher's policies are complied with.
